(19) United States
(12) Patent Application Publication
(10) Pub. No.: US 2006/0191444 A1
(43) Pub. Date: Aug. 31, 2006

(54) Method of producing portland cement

(76) Inventor: Louis E. Wagner, Buffalo, NY (US)

Correspondence Address: TAKEUCHI & KUBOTERA, LLP, SUITE 202, 200 DAINGERFIELD ROAD, ALEXANDRIA, VA, 22314, US

(21) Appl. No.: 11/359,610

(22) Filed: Feb. 23, 2006

Related U.S. Application Data
(60) Provisional application No. 60/655,841, filed on Feb. 25, 2005.

(51) Int. Cl. C04B 2/10

(52) U.S. Cl. 106/739; 106/745

(57) ABSTRACT

A method of producing Portland cement includes the steps of: preparing a raw material of the Portland cement; preparing Municipal Solid Waste (MSW) ash; mixing the raw material and the MSW ash to obtain a mixture; feeding the mixture into a kiln; and operating the kiln to obtain the Portland cement. In the step of mixing the raw material and the MSW ash, the raw material may be mixed with the MSW ash, so that a weight% of the MSW ash is within a range of 1% to 60%. The method of producing Portland cement may further include the step of analyzing the MSW ash to determine a composition thereof, so that the raw material may be mixed with the MSW ash according to the composition of the MSW ash.

### CROSS-REFERENCE TO RELATED APPLICATIONS

This application claims the benefit of U.S. Provisional Application No. 60/655,841, filed on Feb. 25, 2005.

### BACKGROUND OF THE INVENTION AND RELATED ART STATEMENT

The invention relates to a method of producing Portland cement through utilization of ash created by incineration of Municipal Solid Waste (MSW).

In recent years, Municipal Solid Waste (MSW) handling and disposal has received substantial attention by the agencies of the United States Government as well as interested environmental groups. In the specification, Municipal Solid Waste (MSW) is defined as a gross product collected and processed by municipalities and government.

In general, Municipal Solid Waste (MSW) includes durable and non-durable goods, containers and packaging, and food and yard wastes and miscellaneous inorganic wastes from residential, commercial and industrial sources. Examples include news print, appliances, clothing, scrap food, containers and packaging, disposal diapers, plastics of all sort including disposable tableware, home packaging materials, rubber, wood products, potting soil, yard trimmings, and consumer electronics, as part of an open-ended list of disposable or throw-away products. A broad spectrum of the MSW content is described “In characterization of Municipal Solid Waste in the United States; 1990 Update” United States Environmental Protection Agency (EPA) Publication EPN530-SW9O -042 dated Jun. 1990. A substantial portion of the total available MSW is currently being reduced by incineration either by mass burn or through combustion of refuse derived fuel.

While the incineration of MSW remains controversial, it continues to find increasing acceptance due to a number of factors including greatly decreased amount of residual material which must be land-filled and improved operating procedures which emit lower concentrations of pollutants to the atmosphere. The use of incineration is increasing and, as of 1990, over 150 incinerators were combusting about 10% to 15% of the MSW generated in this country.

A by-product of the MSW incineration is ash called MSW ash. The MSW ash represents about one-fourth of a mass of MSW prior to the incineration. A disposal method for the ash is generally land-filling. It has been, therefore, desired to provide a method of utilizing the MSW ash in a more efficient and constructive way.

Portland type 1 cement is produced by mixing basic raw materials comprised of limestone (calcium oxide), shale (aluminate), ferrous oxide, clay (calcium aluminate), and sand (silicon dioxide). These raw materials are heated in a straight rotary cement kiln, so that certain chemical reactions occur. As a result of the chemical reactions, the raw materials are formed into clinkers, and the clinkers are pulverized in a ball mill to produce fine granulated powders. These powders are then subjected to screening and result in Portland type 1 cement in accord with standard specifications.

There are several types of waste materials that are introduced as substitutes for raw materials in the production of Portland type 1 cement powder. A major product currently substituted for the virgin raw material is fly ash generated by burning coal to produce power at power utility plants. A composition of the fly ash is given in a table shown in FIG. 1. Currently, substitutions of the coal fly ash have been done at a number of cement kilns in the United States. The substitutions of the coal fly ash range from 5% to 20% as the norm. For information about utilization of coal fly ash, please refer to US Pat. No. 4,265,671 issued on May 5, 1981. However, the substitutions of the coal fly ash have posed some problems in terms of properties of the final cement product as well as handling properties of the coal fly ash as the raw material during the production process of the Portland cement.

U.S. Pat. No. 6,569,234 has disclosed a cement dispersant which displays high dispersibility with a small addition amount and excellent dispersibility particularly even in a high water-reducing ratio area. In U.S. Pat. No. 6,569,234, there is the following statement (col. 15, lines 12 to 36): “The cement as used in the cement composition is not especially limited. Examples thereof include portland cement (such as standard types, high-early-strength types, ultra-high-early-strength types, moderate heat types, sulfate-resistant types and low alkali types thereof); various mixed cement (such as blast furnace cement, silica cement and fly ash cement); white portland cement; alumina cement; ultra rapid hardening cement (such as 1 clinker rapid hardening cement, 2 clinker rapid hardening cement and magnesium phosphate cement); grout cement; oil-well cement; low calorific cement (low-calorific type blast furnace cement, fly ash mixed low-calorific type blast furnace cement and much belite containing cement); ultra-high strength cement; cement type solidifiers; and ecological cement (such as cement produced from at least one raw material selected from the group consisting of ash from an urban garbage furnace and ash from a sewage garbage furnace).”

In particular, in U.S. Pat. No. 6,569,234, it is stated that the ecological cement is produced from at least one raw material selected from the group consisting of ash from an urban garbage furnace and ash from a sewage garbage furnace. In this case, the ash from the urban garbage furnace and the sewage garbage furnace is meant to be ash of fuel, most likely coal, that is used to burn urban garbage or sewage waste. Accordingly, U.S. Pat. No. 6,569,234 has disclosed utilization of coal fly ash in a way same as that in U.S. Pat. No. 4,265,671.

An object of the present invention is to provide a method of producing Portland cement through utilization of ash created by incineration of Municipal Solid Waste (MSW).

### SUMMARY OF THE INVENTION

In order to attain the object described above, according to the present invention, a method of producing Portland cement comprises the steps of: preparing a raw material of the Portland cement; preparing Municipal Solid Waste (MSW) ash; mixing the raw material and the MSW ash to obtain a mixture; feeding the mixture into a kiln; and operating the kiln to obtain the Portland cement.

According to the present invention, in the step of mixing the raw material and the MSW ash, the raw material may be mixed with the MSW ash, so that a weight% of the MSW ash is within a range of 1% to 60%.

According to the present invention, the method of producing Portland cement may further comprise the step of analyzing the MSW ash to determine a composition thereof before the step of mixing the raw material and the MSW ash. In this case, in the step of mixing the raw material and the MSW ash, the raw material may be mixed with the MSW ash according to the composition of the MSW ash.

According to the present invention, the method of producing Portland cement may be applicable to both dry-process and wet-process. In the wet-process, the method may further comprise the step of preparing a slurry of the mixture before the step of feeding the mixture into the kiln. In the step of preparing the MSW ash, the MSW ash may be prepared from Municipal Solid Waste (MSW) including containers and packaging, food and yard wastes, and miscellaneous inorganic wastes from residential, commercial and industrial sources.

### BRIEF DESCRIPTION OF THE DRAWINGS

FIG. 1 is a table showing a composition of coal fly ash;

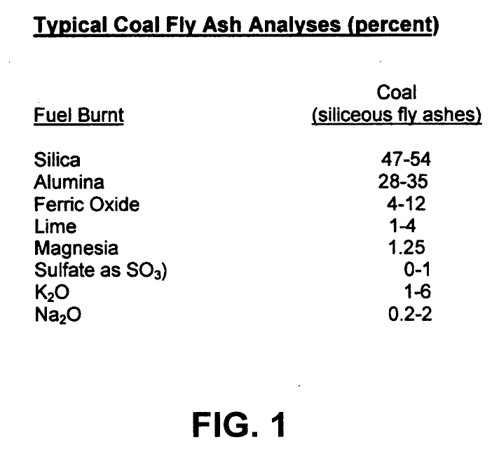

FIG. 2 is a table showing compositions of raw materials of Portland cement;

FIG. 3 is a table showing a composition of MSW Ash;

FIG. 4 is a table showing a composition of Portland cement;

FIG. 5 is a view showing a wet-type process kiln used in a method of producing Portland cement according to an embodiment of the present invention; and

FIG. 6 is a view showing a dry-type process kiln used in a method of producing Portland cement according to another embodiment of the present invention.

### DETAILED DESCRIPTION OF THE PREFERRED EMBODIMENTS

Hereunder, embodiments of the present invention will be explained with reference to the accompanying drawings.

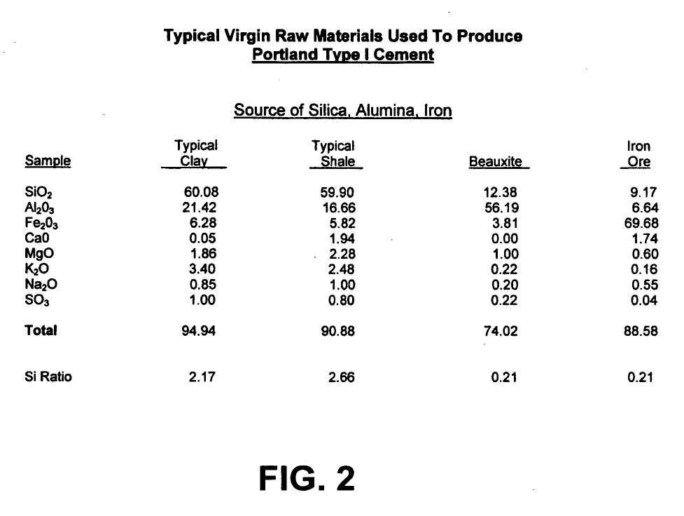

While a variety of raw materials may be used in cement manufacture, materials containing calcium, silica, aluminum, and iron without an excess of certain other elements, are required. FIG. 2 is a table showing compositions of the raw materials of Portland cement.

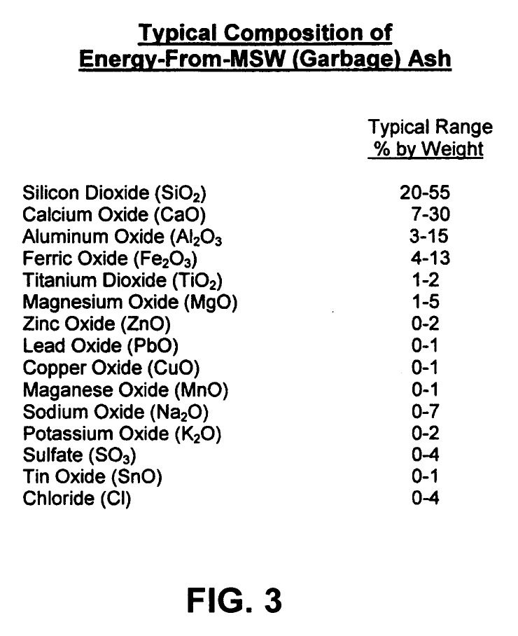

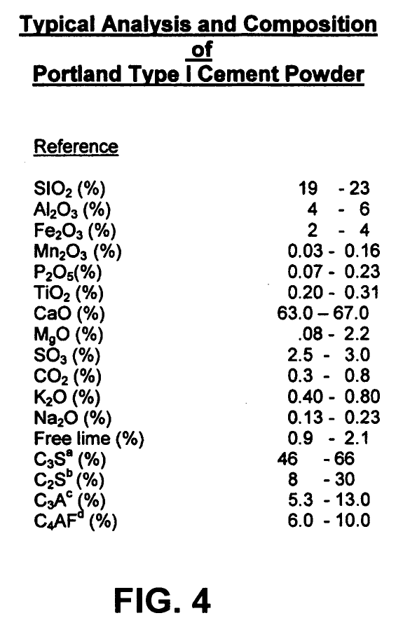

A by-product of municipal solid waste (MSW) incineration includes ash called MSW ash. The MSW ash represents about one-fourth of the mass of the material prior to incineration. An example of a composition of the MSW Ash is given in a table shown in FIG. 3. Since the composition of the MSW ash is very similar to the virgin raw materials used in the production of Portland type I cement shown in FIG. 2, it is believed that the MSW ash can be substituted anywhere from 1% to 60% for those raw materials and produce an end product; namely, the Portland type 1 cement that would result in a concrete product with similar properties to a concrete utilizing a cement powder produced only from the virgin raw materials. The Portland type 1 cement has a composition shown in a table in FIG. 4.

These raw materials are ground to a fine powder called raw meal, a chemical composition of which is carefully controlled by proper blending of the various materials. Normally, blending is achieved by grinding all of the raw materials together (inter-grinding). The raw meals required for wet and dry processes (described later) are similar except the raw material for the wet process is in the form of a slurry made up of approximately 35% water. The raw meal for the dry process contains less than 0.5% water.

The raw meal is fed into a kiln, and is reacted in the kiln to produce an intermediate product called clinker. The kiln slopes toward the burning zone and is approximately 400 feet long with a 9 feet to 14 feet diameter. The kiln rotates slowly causing the raw materials to gradually move in to a burning zone. Reactions which occur during the gradual heating in the kiln are evaporation of free water, evolution of combined water, evolution of carbon dioxide from carbonates, and a combination of lime with silica, aluminum, and iron to form desired compounds in the clinker. These reactions require a final material temperature of 1450° C. (2650° F.). Four major compounds are present in the Portland cement clinker as shown in the following table.

| Name of Compound | Chemical Formula | Common Abbreviations |
|---|---|---|
| Tricalcium Silicate | 3 CaO.Si0₂ | C₃S |
| Dicalcium Silicate | 2 CaO.Si0₂ | C₂S |
| Tricalcium Aluminate | 3 CaO.Al₂0₃ | C₃A |
| Tetracalcium | 4 CaO.Al₂0₃ | C₄AF |
| Aluminoferrite | | |

Minor compounds are also formed in the clinker, commonly magnesia (MgO), potassium sulfate (K₂SO₄), and sodium sulfate (Na₂SO₄). Traces of other elements present in either the raw materials or fuel are also found in the clinker. Upon leaving the kiln, the clinker is rapidly cooled to avoid undesirable crystal forms of the above compounds. After cooling, the clinker is ground and blended, normally by inter-grinding with gypsum to a fine powder. The final product, called Portland cement powder, is a basic ingredient of concrete.

In the burning process, considerable CO₂ is driven from the raw meal. Any elements not driven off are increased in the clinker in proportion to the quantity of CO₂ evolved.

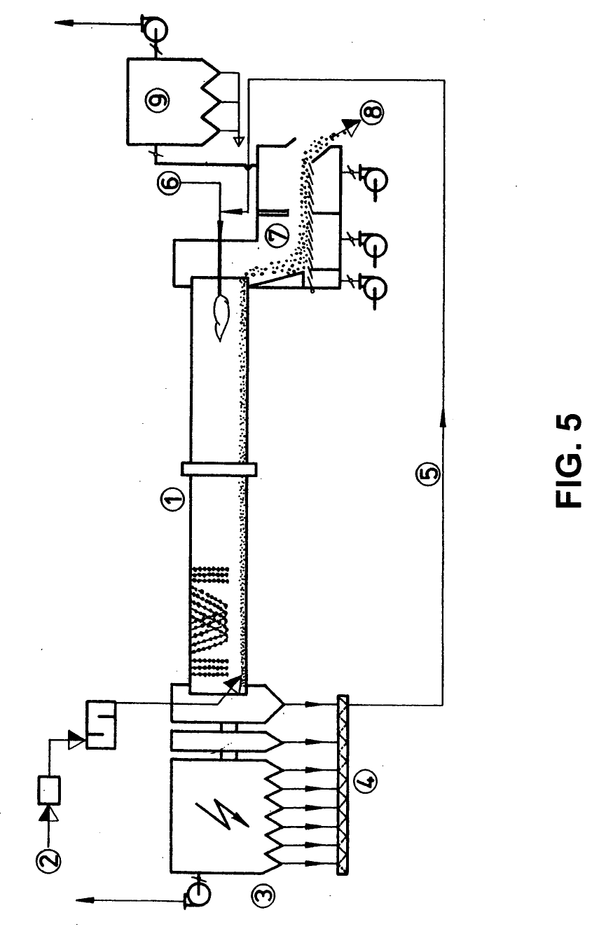

FIG. 5 is a view showing a wet-type process kiln used in a method of producing Portland cement according to an embodiment of the present invention. As shown in FIG. 5, the wet-type process kiln is provided with a kiln 1 having a cylindrical shape; a slurry feed system 2 for feeding a slurry of the raw materials; a precipitator 3 for precipitating gasses generated during the production process; a precipitator dust screw 4; a dust return path 5 for returning dust to the system; a fuel path 6 for feeding burning fuel; a clinker cooler 7 for cooling clinkers 8 discharged from an end of the kiln 1; and a filter 9 for filtering combustion gas.

An example of the wet-type process kiln will be explained next. A dumbbell-shaped Allis Chalmers kiln is 402 feet long with a diameter of 11 feet 6 inches, having a nominal capacity of 1,050 short tons per day. A chain system (not shown) in a drying zone has 57 tons of loose hung carbon steel chains with a radiation curtain at the front (flame end) of stainless steel chains. The chain system extends through 87 feet of the kiln length. The slurry feed system 2 is a bucket wheel conveyor with a variable speed drive taking the slurry from a constant level box. Gases from the kiln (maximum capacity 150,000 CFM at 1150° F.) pass through the six-section electrostatic precipitator 3. Gases from the precipitator 3 are exhausted via a common stack 554 feet in height with 13 feet exit inside diameter. Fuel oil through the fuel path 6 is burned in a single burner at the centre of a burner pipe.

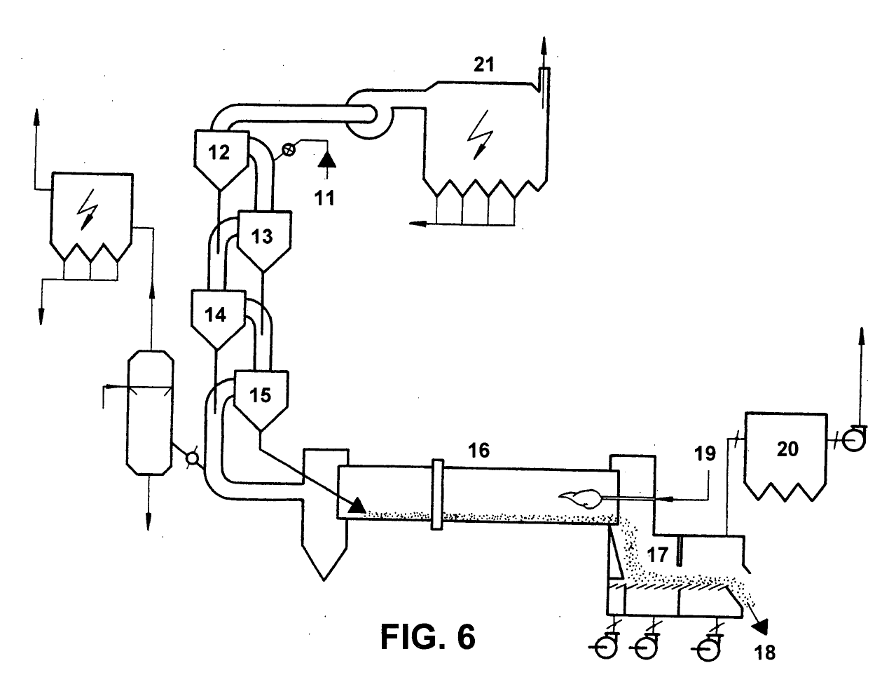

FIG. 6 is a view showing a dry-type process kiln used in a method of producing Portland cement according to another embodiment of the present invention. As shown in FIG. 6, the dry-type process kiln is provided with a raw meal feed path 11 having a first stage 12, a second stage 13, a third stage 14, and a fourth stage 15; a kiln 16 having a cylindrical shape; a clinker cooler 17 for cooling clinkers 18 discharged from an end of the kiln 16; a fuel path 19 for feeding burning fuel; a filter 20 for filtering combustion gas; and a precipitator 21 for precipitating gasses generated during the production process.

An example of the dry-type process kiln will be explained next. A Traylor unit kiln is a 17 feet in diameter and 276 feet long normally fired through three nozzles at an end of the fuel path 19. For the test, chlorinated hydrocarbons are injected via a nozzle at the centre of the triangle formed by the three oil nozzles. A suspension pre-heater consists of the first through fourth stages 12 to 15, through which hot exit gases from the kiln are drawn by a fan. The raw meal passes through the system in counter flow to the gas. The raw meal is introduced into a duct between the first and second stages 12 and 13, and is swept with the hot exhaust gases into the uppermost first stage 12 where the gas and the raw meal are separated. The raw meal from the first stage 12 drops into the duct between the second and third stages 13 and 14, and is again suspended and separated.

This procedure, being swept up with the hot gases and then being dropped into the stream entering the next lowest stage, is repeated in the third and fourth stages 14 and 15 before the raw meal enters the kiln 16. The raw materials entering the first stage 12 are preheated to approximately 300° C. (600° F.), while the gas temperature drops from 530° C. (990° F.) to 340° C. (650° F.). At each stage, corresponding heat exchanges occur such that the material enters the rotary kiln at approximately 800° C. (1475° F.) having been partially de-carbonated. The gas temperature at the point of exit from the kiln into the pre-heater is about 1040° C. (1900° F.) to 1090° C. (2000° F.).

The process begins as the raw materials such as limestone, shale, clay sand, and the like, either wet or dry, are fed in specific portions into the back end of the straight rotary cement kiln. The raw materials travel toward the front end of the kiln as the kiln turns. Initially, these raw materials give off water vapor (dehydration) and then give off CO₂ (calcinations). Finally, in the hottest end of the kiln, the final reactions occur and the material clinker falls out of the kiln into the cooler where it is quenched.

The raw materials used in the cement manufacture are containing calcium, silicon aluminum, and iron. These materials are generally ground into a fine powder and blended to the composition desired in the resulting clinker. This is normally achieved by grinding all of the raw materials called inter-grinding. It is at this time a decision to substitute the MSW ash for a portion of the raw materials is made, and the substitution generally would be in the range of 1% to 60%, more preferably 5% to 20%. Then, the ash is blended in with a predetermined total amount of the raw meal in the area of 5,000 to 10,000 tons. The raw meal including the MSW ash is fed into the kiln of the wet-process or the dry-process (see FIGS. 5 and 6), and is reacted in the kiln to produce the clinker. Natural gas is used as start fuel, and then the MSW ash sustains the flame.

The components of the incinerator ash, namely ash derived from the burning of garbage, i.e., Municipal Solid Waste (MSW), include substantially the same raw materials that are constituents of Portland type 1 cement, namely, calcium oxide, calcium aluminate, ferrous oxide, and silicon dioxide. According to the invention, the method of producing Portland cement may include the steps of acquiring ash produced from municipal solid waste; analyzing the ash to determine its constituents; and substituting a portion, in the range of 1% to 60%, of the raw materials normally utilized to produce Portland type 1 cement. When the substitution is less than 1%, it is difficult to obtain meaningful benefit of the substitution. When the substitution is more than 60%, the composition of the final product, i.e., the Portland cement, may be deviated from an optimal one, thereby resulting in a lower strength of concrete.

The ash from incinerated municipal solid waste typically includes a fairly large variation in the size of particles and clinker. This ash can be screened, dried and crushed and analyzed to determine its major constituents prior to introduction into the cement kiln.

As is readily apparent from the foregoing, the four major constituents of the MSW ash are comprised of the major constituents necessary to produce Portland type 1 cement.

Accordingly, the substitution of the MSW ash in the range of 1 to 60 percent at the entrance to the kiln will result in the required chemical reactions as the materials pass through the kiln for effectively producing the Portland cement having the same characteristics when utilized in concrete without any degradation in compression strength, tensile strength, or other physical properties.

Generally, the advantages of using the MSW ash over the coal fly ash are: an economical factor; and a reduced amount of produced Carbon Monoxide during the production process. The cement manufacturers are paid by the generators of the coal fly ash between $1.00 and $3.00 per ton. This revenue stream plus the savings in regard to purchasing virgin raw materials constitutes the major reason why the cement companies utilize the coal fly ash.

According to the present invention, in regard to utilizing the MSW ash, the benefits are magnified in the sense that the generators of the MSW ash are willing to pay the cement manufacturers substantially more money per ton in the range of $10 to $15 per ton for the cement manufacturers to utilize the MSW ash in the production of Portland type I cement. The reason for the MSW generators to pay that amount of money is that they are currently paying that amount or greater amounts of money to have the material land-filled in properly designed landfills.

By replacing landfills in a sense that the material is recycled, there is an appreciable environmental advantage, namely, preventing any harmful substance from leaching out landfill that could escape into the environment. Essentially, the result is an economic advantage as well as the environmental advantage. In regard to the advantage as opposed to using the coal ash, the advantages are better economics and the fact that there is less unburned carbon in the MSW ash. Further, when the MSW ash is utilized, carbon monoxide is produced in a less amount than that would be generated when using the coal ash.

Currently, almost all of the MSW ash is land-filled as a method of disposal. The potential environmental damage comes from the possibility of heavy metal contained in the MSW ash leaching into groundwater; most notably chromium and lead. Utilization of the MSW ash in the Portland cement production does not render the cement material hazardous, and the MSW ash becomes a part of the product, namely concrete. So, in essence, the generator of the garbage ash; namely, the energy-from-waste processor, provides a perfect disposal option for garbage; namely, burning the garbage, controlling air emissions with the necessary scrubber equipment, and then recycling the MSW ash as a part of the cement product. Simply put, that means there is no waste material left over. Thus, the present invention provides a perfect environmentally sound solution for the disposal of garbage.

What is claimed is:

1. A method of producing Portland cement, comprising the steps of:
preparing a raw material of the Portland cement;
preparing Municipal Solid Waste (MSW) ash;
mixing the raw material and the MSW ash to obtain a mixture;
feeding the mixture into a kiln; and
operating the kiln to obtain the Portland cement.

2. The method of producing Portland cement according to claim 1, wherein, in the step of mixing the raw material and the MSW ash, the raw material is mixed with the MSW ash so that a weight% of the MSW ash is within a range of 1% to 60%.

3. The method of producing Portland cement according to claim 1, further comprising the step of analyzing the MSW ash to determine a composition thereof before the step of mixing the raw material and the MSW ash.

4. The method of producing Portland cement according to claim 3, wherein, in the step of mixing the raw material and the MSW ash, the raw material is mixed with the MSW ash according to the composition of the MSW ash.

5. The method of producing Portland cement according to claim 1, further comprising the step of preparing a slurry of the mixture before the step of feeding the mixture into the kiln.

6. The method of producing Portland cement according to claim 1, wherein, in the step of preparing the MSW ash, the MSW ash is prepared from Municipal Solid Waste (MSW) including durable and non-durable goods, containers and packaging, and food and yard wastes and miscellaneous inorganic wastes from residential, commercial and industrial sources.

7. The method of producing Portland cement according to claim 1, wherein, in the step of operating the kiln to obtain the Portland cement, the kiln is heated at a first temperature higher than 1,000° C.

8. The method of producing Portland cement according to claim 1, further comprising the step of pre-heating the mixture before the step of feeding the mixture into the kiln.

9. The method of producing Portland cement according to claim 7, further comprising the step of pre-heating the mixture at a second temperature lower than the first temperature before the step of feeding the mixture into the kiln.

10. Portland cement produced with the method according to claim 1.
